(19) United States
(12) Patent Application Publication
(10) Pub. No.: US 2021/0404256 A1
(43) Pub. Date: Dec. 30, 2021

(54) Peazy Paint Pail

(71) Applicant: Melia E Welch, Arnold, MO (US)

(72) Inventor: Melia E Welch, Arnold, MO (US)

(21) Appl. No.: 17/197,046

(22) Filed: Mar. 10, 2021

Related U.S. Application Data
(60) Provisional application No. 63/044,577, filed on Jun. 26, 2020.

(51) Int. Cl. E06C 7/14; B44D 3/12

(52) U.S. Cl. CPC E06C 7/14; B44D 3/122

(57) ABSTRACT

Systems and methods are disclosed herein for a paint bucket holder allowing the painter to use the paint bucket panel at any height while maintain enough quantity of two types of paints. The paint bucket: holder is kept at upright position with two separate portions for receiving brushes. The brushes compartment is magnetic in nature to ensure that brushes are kept erected while not in use. The paints can he covered and locked, furthermore assembly can be clipped to any part of ladder thus it is universal in nature. The whole construction is highly portable and ladder can be easily moved while bucket: is attached.

### BACKGROUND

### Field of the Invention

he present invention relates to paint buckets and like containers used commonly by individuals, such as painters, to transport a fluid, such as paint, for application to an object.

### Description of the Related Art

Paint buckets up till now have almost always been needed/used in some fashion for brush dipping, brush wiping, and brush holding. It is desirous to comfortably hold or support a bucket while in use; to have an easy-to-dip-into bucket; to have a means to keep a paint implement out of the paint; to have a means to keep the rim clean and paint from dripping out of the bucket; to compactly stack buckets to reduce shipping costs and shelf space; and to have the bucket to be easily cleanable. Additionally pouring from and sealing a bucket would be benefits. It is a crowded art, yet prior art buckets have not yet fulfilled all these basic needs with a single bucket.

Most painters prefer to work out of paint buckets or containers other than an original paint can for several reasons. First the original container is less likely to become fouled by paint dripping into the sealing ring. At the end of a session, the painter must clean any excess paint remaining in the sealing grooves. Otherwise, it is difficult to reseal. Such improper container sealing may cause paint at the surface in the original can to interact with air and form a film. Secondly a paint bucket enables a painter to portion off only the amount of material needed to complete a job. In the case of quick drying materials, only the amount that can be used within the working life of the material may be portioned off. Third, when painting requires several gallons of paint, multiple original cans can be mixed in one large container and then returned to original containers to assure a more consistent paint color. Then the paint can be poured from the original container into a paint bucket as it is needed. Thereafter, the painter may use smaller amounts of paint in a secondary container to minimize any material spilled should the paint pail become overturned during use.

When painting, a painter dips the brush into the paint to load the bristles. Then many painters remove excess paint by scraping the bristles on the most convenient edge of a pail or attachment, this edge usually being the outermost rim or edge. Eventually paint accumulates on the rim. This paint then drips from the outer scraping edge and either falls onto whatever surface is underneath the paint bucket or runs down the exterior of the bucket to such a surface with possible damage to such a surface.

A number of attachments have been proposed that mount on original paint cans while generally they are effective in protecting the can and sealing mechanism, they are often ineffective in protecting whatever is underneath the paint can. Nearly 100 patents were researched via the US Patent and Trademark Office Database on the intern& from the field of paint container holders. Most of the patents researched were from a non-analogous art. Some involved a paint bucket holder that attached to the user's silhouette, others mounted on a step ladder, others either clamped to the edge of an extension ladder or were hung from a ladder rung. The eight patents listed herein were found to apply to the art of a paint bucket holder using a ladder hollow rung for attachment. All eight of these inventions have disadvantages that the present invention overcomes. There is a basic over-all security issue with all eight inventions, due generally to the approach to attachment of the paint can to the ladder hollow rung. The paint bucket has the capability to essentially swing or rotate about the horizontally disposed axis established by the support arm inserted in the hollow rung. This is generally done to maintain the paint bucket in a level, upright orientation. The disadvantage of this approach is that it creates a perception of insecurity on the part of the user due to movement of the paint bucket while paint is being extracted with a brush, especially as the level of the paint in the bucket decreases. The degree of risk of this movement during usage is invention specific, dependent upon the support arm cross section design.

U.S. Pat. No. Inventor Issue Date 5,934,632 Norman W. Weaver Aug. 10,1999 US. Pat. No. 5,845,742 Erin Jessica & Robert Thomas Tade Dec. 8, 1998 U.S. Pat. No. 5,649,682 Julius F. Martin Jul. 22, 1997 U.S. Pat. No. 5,316,251 Raymond V. McGraw May 31, 1994 U.S. Pat. No. 4,824,060 Edward S. Korda Apr. 25, 1989 U.S. Pat. No. 4,702,446 Franklin C. Brown Oct. 27, 1987 U.S. Pat. No. 4,523,733 Charles K. Lunder, Jr. Jun. 18, 1985 U.S. Pat. No. 4,099,693 Ellis L. Mann Jul 11, 1978.

U.S. Pat. No. 5,934,632 by Weaver describes a utility can holder for use with hollow rung ladders, The paint can or bucket rests with the bail connecting knobs, or alternately, the bucket lip, contacting the upper surface of an annular support member. This support member is rigidly attached to a rung insert member which extends completely through the ladder hollow rung from one side to the other. Flexible tabs are compressed prior to insertion of this member into the rung and then open on the other side of the ladder to prevent inadvertent extraction from within the rung. The annular support member is rotatable within the rung to allow leveling of the paint bucket. This rotatability may cause instability as the user extracts paint from the bucket, as discussed in the preceding paragraph. it is also evident that the positioning and attachment of the paint bucket on the ladder is a two step procedure. The rung insert member must be secured within the selected ladder hollow rung prior to inserting the paint bucket into the container recess. The insertion of the rung insert member into the hollow rung is a “two hand operation”, involving holding the approximately 30 inch long holder with one hand and depressing the flexible tabs with the other hand. Only after the rung insert member is in place can the user climb off the ladder and transport the paint bucket back up the ladder to insert it into the container recess. Thus, significant complication is involved with moving the paint can holder from position to position on the ladder.

U.S. Pat. No. 5,845,742 by fade describes a paint can or bucket hanging by its bail from a T-shaped support member which is attached to one end of an extension member. The rod-like extension member is inserted into a ladder hollow rung. The paint bucket is supported by its bail which is vertically disposed directly above the lip of the paint bucket. This positioning of the bail interferes with extraction of the paint from the bucket with a paint brush.

U.S. Pat. No. 5,649,682 by Martin supports a container within an encircling cincture formed from a flattened projecting arm that is inserted into a ladder hollow rung. The support part of the projection arm that is inserted. into the ladder hollow rung is relatively short and is not attached. securely within the hollow rung. There is, at least, the perception of this device being a security risk due to the real possibility that the arm may be inadvertently extracted from the rung opening during usage.

U.S. Pat. No. 5,316,251 by McGraw is directed at leveling a paint can in two dimensions. The paint can rests upon a wrap around frame that is elliptical shaped and may be either closed or open at one end. This frame is rigidly attached to a cylindrical handle that is inserted into a ladder hollow rung to support the frame and the paint can. The disadvantage of this approach is that the paint bucket may be dislodged from its position atop the frame and, at least, spill some or all of its contents, or at worst, be a safety hazard to persons on the ground. As with the invention by Martin, the cylindrical handle is relatively short compared to the length of the ladder rung and is not secured within the ladder rung. in addition, in one embodiment of the invention, the paint can is not enclosed on one side by the wrap-around frame, increasing the risk of dislodgment. Both of these conditions contribute to the perception of insecurity by the user.

U.S. Pat. No. 4,824,060 by Korda provides a holder for supporting a paint bucket or can that is basically a cradle in which the paint can rests on a plate and is contained within a cylindrical member slightly larger in diameter than the outside of the paint can. A detachable rod is inserted through the ladder rung such that a swing plate latch falls vertically and secures the rod from extraction from the rung. The “cradle”, containing the paint bucket is attached to the other end of the rod. Korda's approach provides a higher degree of security than is available for the inventions previously discussed, However, the procedure for mounting the paint bucket onto the ladder is fairly complicated, not providing for ease of movement to another rung on the ladder by the user. The rod is mounted at the desired position on the ladder before the holder is attached to the end of the rod, followed by insertion of the paint bucket into the holder cradle. This procedure appears to involve at least two, and maybe more, hips up the ladder, and is not compatible with easily and conveniently changing the position of the paint can while the user is working on the ladder.

U.S. Pat. No. 4,702,446 by Brown provides a holder very similar, though not quite as secure as Korda, which is also attached to a holding arm which is inserted into a ladder hollow rung. As discussed previously for the invention by Martin, the holding arm is relatively short, and although Brown has provided soft rubber friction sleeves at both ends of the arm to restrict slippage, there is still risk that the arm could be inadvertently extracted from the rung opening during usage. The interior of the ladder hollow rung is not circular and will not make continuous, firm contact with the circular shaped friction sleeves. Further, the friction sleeves may make minimal contact with the rung interior for a specific application since the cross-section shape and size of the hollow rung interior varies significantly for ladders manufactured over the last two decades.

U.S. Pat. No. 4,523,733 by Lundell contains the paint container on a seat, enclosed on all four sides by vertical flanges, bent perpendicular to the seat. A rod is inserted entirely through holes in, and is rigidly attached to, two triangular shaped flanges at opposite ends of, and perpendicular to, the seat. This rod is inserted into a ladder hollow rung to support the paint container. The paint container may rotate with the rod, about the horizontal axis of the rod, creating a perception of insecurity. The rod extends across the center of the mouth of the paint container and interferes with extraction of paint using a brush. Also, as with the Martin and Brown inventions, the end of the rod that is inserted into the hollow rung is relatively short and is susceptible to being inadvertently dislodged from within the hollow rung.

U.S. Pat. No. 4,099,693 by Blann supports a paint bucket by hooking the bail of the bucket over a short upturned projection on an elongated member that engages the hollow rung. A short downward projecting bracket holds the vertical, cylindrical edge of the bucket. The elongated member is essentially a rod with an upward bend on the end that extends through the hollow rung. This bend hooks the outer surface of the ladder leg to prevent extraction from the rung. As with the invention by McGraw, there is a perception of a substantial security risk with the use of this device. The paint bucket could be accidentally dislodged, particularly when the paint level in the bucket is low so that the pressure holding the bucket against the container side support bracket is reduced. Additionally, the diameter of the rod, engaging the ladder rung, is small compared to the rung interior dimensions and could cause the bucket to wobble as paint is removed.

Moreover, the inventor recognized the need to safely and securely attach a paint bucket to a ladder in a conveniently accessible location such that his hands would be free to grip the ladder and maneuver the paint brush while working on the ladder. The inventor fabricated a crude first model of his invention from plywood and other left over wooden items and found that his concept generally satisfied his need. He developed the improvements to this original model to provide capability for easily moving the apparatus from one side of the ladder to the other while he was standing on the ladder. A prototype, including the improvements, has been built and tested by the inventor to validate the claims of this invention.

Looking at the prior art there are no advancements that have been seen in similar regards. There is no such solution is found which facilitates the user in providing them a single unit which can carry multiple types of paints and brushes while standing on a Ladder. The current invention proposes an assembly which fulfils the above-mentioned needs.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of an improved method developed to provide a paint bucket holder to safely and securely contain paints while attached easily, conveniently, securely, and removably to a hollow rung ladder.

It is also the objective of invention to provide paint bucket which is maintained in a near upright disposition over a range of typical and safe extension ladder inclinations.

It is further the objective of the invention to provide means for the paint bucket holder and paint bucket act as a single unit which is transportable and attachable, with one hand, to a selected hollow rung on a typical extension ladder.

A further object of the invention is the paint bucket which has magnetic compartments to place the paint brushes.

It is also the objective of the invention to provide assembly which can be attached to the ladder, the unit is not susceptible to being inadvertently dislodged and provides convenient access to the paint in the bucket with no interference.

Another object of the present invention is to facilitate positioning and orientation of the paint bucket holder on the ladder is such as to minimize contact with any structure supporting the ladder and to maintain the paint bucket in a near upright disposition over typical, safe ladder inclinations.

Another object of the present invention is to provide an assembly which is aesthetically pleasing and comes in variety of colors.

It is also the objective of invention to provide paint bucket and brush holder are transported, as a single unit, with one hand.

It is further the objective of the invention to provide a system which is easy to use, easy to implement and provides an advance methodology of carrying multiple paints at heighted locations.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a full view of the invention.

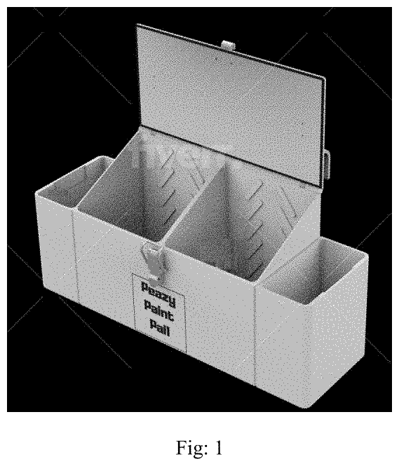

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

As per exemplary embodiments of the invention, a paint bucket holder, removably attachable to a selected side of a ladder having hollow rungs and a pair of closed compartments to receive paints is designed. The two compartments on both ends are provided with magnetic properties to hold the brushes. The rectangular base plate providing a flat, generally horizontal surface for supporting a paint bucket at any place.

The preferred material for the t at, rigid, container base, upright panel of paint bucket container is gauge sheet metal. Sheet metal is readily available from multiple commercial sources, is a good compromise between rigidity and weight, and can be easily bent such that container base and upright panel or container base can be constructed from a single contiguous sheet. This material selection is only illustrative for the preferred embodiment of the present invention as other materials, such as wood or molded plastic or fiberglass could also be used. A combination of wood, plastic, or fiberglass for some elements and metal for the other elements is also a credible consideration. Commercially available bungee cord is preferred for elastic cincture although other suitable elastic materials could be used, Dimensions for these elements are primarily chosen to be consistent with the size and shape of paint bucket.

As discussed, the, clips are rigidly attached to the front surface of upright panel to facilitate clipping of clips with ladder, Thus, allowing for sufficient length to provide adequate leverage for supporting and maintaining essentially full, paint bucket substantially upright while avoiding interference with ladder leg.

The present invention is an innovative, :fresh approach to advance the art of attaching a paint bucket to ladders. The emphasis of the invention is primarily directed toward addressing the key issues presented by security and safety. Prior art in this field has placed emphasis on paint can leveling, reduction of moving parts, and simplicity of use. The present invention does not ignore these important aspects. The preferred embodiment maintains the paint bucket level within acceptable limits based on typical and safe use of an extension ladder for painting a structure. Moving parts have been reduced to the rung attachment arm which is positionable within a structure. Moving parts have been reduced to the rung attachment arm which is positionable within the arm support sleeve to provide a convenient and easy way to switch the paint bucket from one side of the ladder to the other. The paint bucket holder of the present invention is self-contained, easy to use, and is readily manufacturable to produce economical units in quantity. A commercially available paint bucket holder is currently lacking, and t ns invention promises to fill that void.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1: A paint bucket holder, removably attachable to a selected side of a ladder having hollow compartments with lids to hold paint and a pair of side compartments to hold brushes, where interiors of said assembly being accessible through openings, said holder comprising:
(a) a generally rectangular base plate providing a flat, generally horizontal surface for supporting multiple paints compartments;
(b) a generally rectangular upright panel having a bottom edge connected at a substantially right angle to a rear edge of said base plate and having a top edge at a location above a top of said paint bucket;
(c) a horizontal, rectangular assemblies at both ends for storage of brushes;
(d) a pair of clips adapted for slidably receiving said portion of ladder, being rigidly connected to ladder;
(f) a closing lid to store paint properly once not in use; and
(g) a bucket which can be moved easily while the ladder is moved
